(19) United States
(12) Patent Application Publication
(10) Pub. No.: US 2016/0364455 A1
(43) Pub. Date: Dec. 15, 2016

(54) System and Method for Operational Constraints in Social Networking

(71) Applicant: Benjamin Singer, Santa Monica, CA (US)

(72) Inventor: Benjamin Singer, Santa Monica, CA (US)

(21) Appl. No.: 14/737,091

(22) Filed: Jun. 11, 2015

(51) Int. Cl. G06F 17/30; H04L 29/08

(52) U.S. Cl. CPC G06F 17/30528; H04L 67/12; H04L 67/306; H04L 67/10; H04L 67/02; G06F 17/30525; G06F 17/30867

(57) ABSTRACT

This document presents a system and method for interaction with a social networking site where a user may be constrained from using some features of the site based upon pre-defined conditions. A social networking site such as a personal matching site may set a definite number of matches an individual user may make. Once all matches have been made, the user may be constrained against actions such as searching until the user has investigated those matches already made or has removed at least one match to free up a slot for the data from a new match to be entered into that slot. Constraints may be defined to prohibit any feature of the social networking site to control those features that are determined to be most subject to constraint enforcement.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The present invention relates generally to search and interaction with one or more social networking sites. Security settings for social networking sites are well established and pertain to interaction with the site as pre-established settings for permitted interaction. Each user is permitted to establish such use settings and may also pertain to individual applications downloaded and used on mobile devices as well as computers.

However, such pre-established settings generally are global settings that, once set, continue to operate until re-set by a user. Many social networking sites permit a level of interaction by a user such that updates are easily performed, but an automatic change in the use and interaction with a site so as to constrain use as part of the automatic operation of the social networking site is not generally known or used by social networking sites in common use.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an interaction display for a social interaction on a mobile social networking application consistent with certain embodiments of the present invention.

FIG. 2 is a view of an automatic constraint against action on mobile social networking application consistent with certain embodiments of the present invention.

FIG. 3 is a view of navigation when expressing no interest on the mobile social networking application consistent with certain embodiments of the present invention.

FIG. 4 is a view of navigation when expressing interest on the mobile social networking application consistent with certain embodiments of the present invention.

FIG. 5 is a flow diagram for operation of the social networking application consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “mobile device” refers to any handheld device such as, but not limited to, a smart phone, tablet, iPad, network computer, watch or any other device a user may carry when travelling from place to place and interact with one or more networks.

Reference throughout this document to “social networking” refers to software tools and applications accessible through computers and mobile devices that permit social interaction between the user of the device and other individuals connected to one or more networks. Devices that may be used to access a social networking site to permit social interaction include smart phones, iPads, tablets, internet computers, watches, and browsers installed on any computer.

Reference throughout this document to “matching” refers to the process of connecting individual users who have specified a preference to meet other people and fostering an online meeting based upon the desire to meet expressed when interacting with a social networking application.

Reference throughout this document to “slot” refers to match slots serving as entry spot placeholders in a selection table in which a user may install the particular details for a person with whom the user is interested in interacting further on a social basis.

Reference throughout this document to “swiping” refers to a user placing a finger or other body part on the surface of a smartphone, iPad, tablet, internet computer, or any device with a touch sensitive screen display and moving the body part in a horizontal direction so as to move the current screen display to the left or right and reveal a new display screen as a result of the swiping action.

In an exemplary embodiment, there is herein disclosed a social networking system and method displaying individual member information on a display associated with a computer or mobile device and associating with a first user a pre-configured number of match slots maintained by a social networking system. The system and method permits searching an individual member database to present a series of views of individual members of the social networking system to the first user.

In this exemplary embodiment, the first user may select a view of an individual member of the social networking system and transfer detailed data associated with the selected individual member to a match slot associated with the first user. The social networking system permits or constrains the first user from continued interaction with the social networking system based upon at least one of the pre-configured number of match slots associated with the first user being available for association with selected individual member information. The individual member information is maintained in a database of individual member information that is searchable by a social networking system search function. Additionally, the display is optimized for a browser display on a computer system or optimized for display on a mobile device such as an internet computer, smart phone, iPad, tablet, or any other internet capable mobile device.

In an embodiment, the selection function is operated by a first user through a swiping action by the first user, where the first user swipes a display to move a presented individual member display in either a first direction or a second direction opposite to the first direction, and where the first direction indicates selection of that individual member. Constraining a first user comprises locking access to pre-configured social networking functions so as to remove those social networking functions from access by the first user. Permitting access to a first user further comprises unlocking and restoring access to pre-configured social networking functions when any one of the match slots is accessible. In a non-limiting example, a match slot becomes accessible when the first user indicates to the social networking system that individual member information associated with any match slot should be disassociated from that match slot.

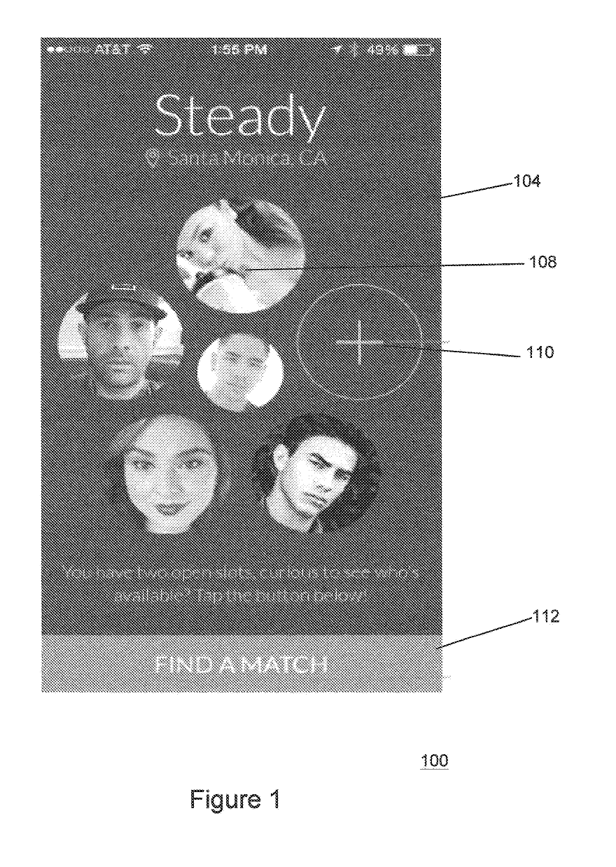

Turning now to FIG. 1, this figure presents a view of an interaction display for a social interaction on a mobile social networking application consistent with certain embodiments of the present invention. In an exemplary embodiment, a social networking system instantiates an application to present a site display on a network capable computer or mobile device to interact with a social matching capability 100. The social networking site 104 displays a view of a pre-configured allotment of match slots 108 for the insertion of details of individuals with whom a first user would like further social interaction. In an embodiment, when a slot 108 is open, meaning there are no details for a selected individual assigned to that slot 108, the slot 108 may contain an indication that the slot 108 is unused.

By way of example, an open slot 108 may contain a plus sign, an “X”, or any other desired graphic icon 110 to indicate that the slot 108 is unoccupied. When a first user has any one of the allotted slots 108 open, tapping on the graphic icon 110 may begin the search process for the details of an individual the first user may then insert into the unoccupied slot 110.

Alternatively, once again if the first user has one or more open slots 108, the display may present a “Find a Match” icon 112 on the display to permit activating the search process. Selecting the “Find a Match” icon 112 initiates the search process to permit a first user to search for information about other individuals on the site in which they may have an interest. The “Find a Match” icon 112 is available for use if the first user has any one of their allotted slots open.

Selecting either the graphic icon 110 in an open slot or the “Find a Match” icon 112 permits the first user to review the details of other individuals who are subscribed to the social networking site. When the first user decides upon a “Match” by selecting the profile of another individual whom they would like to interact with further, the details from the profile of the selected individual will be inserted into the open slot by the system. The unoccupied slot graphic icon 110 may then be replaced by the display of a photo of the matched individual, or of any other graphic display that the matched individual has authorized as a graphic representation of their profile details. This process of matching by the first user may continue until all unoccupied slots are filled with graphics representative of the individuals with whom the first user has selected as a match.

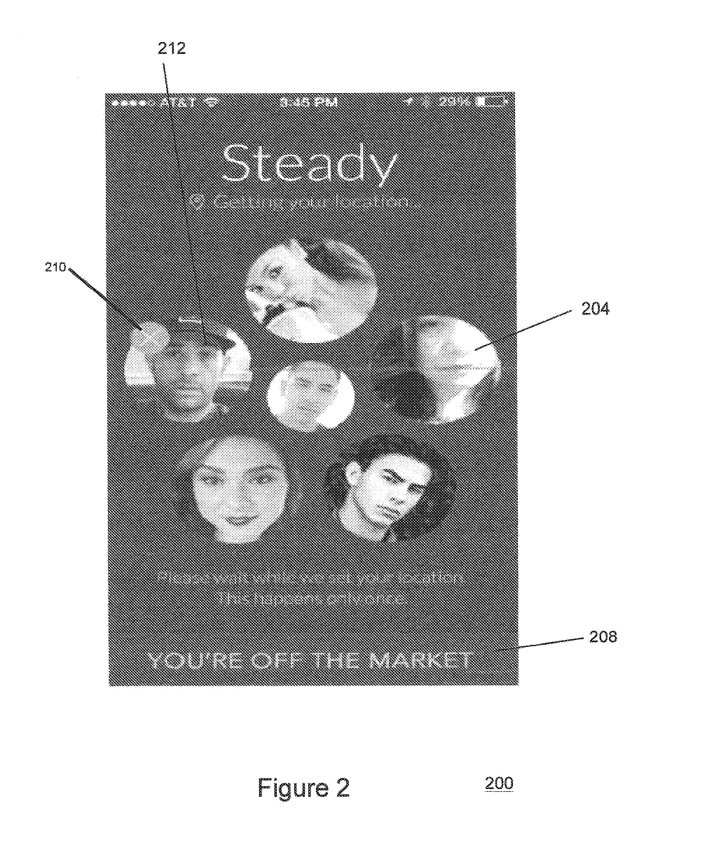

Turning now to FIG. 2, this figure presents a view of an automatic constraint against action on the social networking application consistent with certain embodiments of the present invention. In an exemplary embodiment, the system presents constraints against action when pre-determined actions have occurred. In this embodiment, the social networking system presents a display of the first user's profile display 200 when all slots 204 have been filled. Each slot 204 now contains the graphic representation of a selected individual, indicating that the profile details for each selected individual have been stored within the database that maintains slot information as the results of matching activity by the first user. Because all slots 204 contain profile information for a selected individual, the first user is now subject to constraints on further action.

In an embodiment, constraints on first user interaction with the system are placed upon the first user interaction so as to achieve an operational goal of the social networking system. As an example, an operational goal of the social networking system may be to require a first user to complete an interaction with each of the individuals the first user has selected as a match. The interaction may consist of continued interaction on the site, temporary interaction, communication through other channels, or physical meetings outside of the social networking site. Until the first user has completed their interaction with any or all of the matched individuals, as indicated by the opening of one or more slots associated with the first user, the constraint on further interaction with the social networking site will remain in force.

The system may be pre-configured to place constraints on the interaction of the first user so long as all of the slots 204 are filled with details of matched individuals. The constraint on interaction with the social networking site may take different forms based upon the configuration that the social networking site has determined to be the appropriate constraint. In a non-limiting example, a constraint may take the form of not permitting further searching action by the first user so long as all of their slots 204 contain information from previously matched individuals. As an example of this constraint, the social networking display may present a graphic icon on the display such as “You're off the market” 208 as a visual reminder that the first user may be constrained from further searching activity until the first user opens a slot 204 by indicating that the matched individual in that slot 204 should be removed. In this non-limiting example, the alternative search button 208 on the system display becomes inactive when all slots 204 are filled.

The removal of a matched individual from a slot 204 may be accomplished, in a non-limiting example, by the first user selecting the graphic icon for a slot 204 and holding down the selection key when the selection cursor is placed on the graphic icon for the slot 204 until a red “X” appears 210. The red “X” 210 indicates that the details for the matched individual in that slot 204 are being removed. Upon removal, the slot 204 may return to the pre-configured graphic icon indicating that slot 204 is empty. Upon achieving one or more empty slots 204 once again, the constraints are removed, as indicated by the “You're off the market” icon 208 being replaced by a “Find a Match” icon (not shown). The first user once again may access all functions of the social networking site and the alternative search button 208 is once again an active control to initiate searching activity.

The constraint against searching is simply one exemplary type of constraint that may be applied when all slots 204 have been filled with the details of matched individuals. Additional exemplary constraints may take the form of permitting a first user to continue to search, but deny the storage of newly matched individuals until the first user empties a slot 204 of the details of a previously matched individual so as to store the details of the newly matched individual. Additional exemplary constraints may be designed and implemented as operational conditions require.

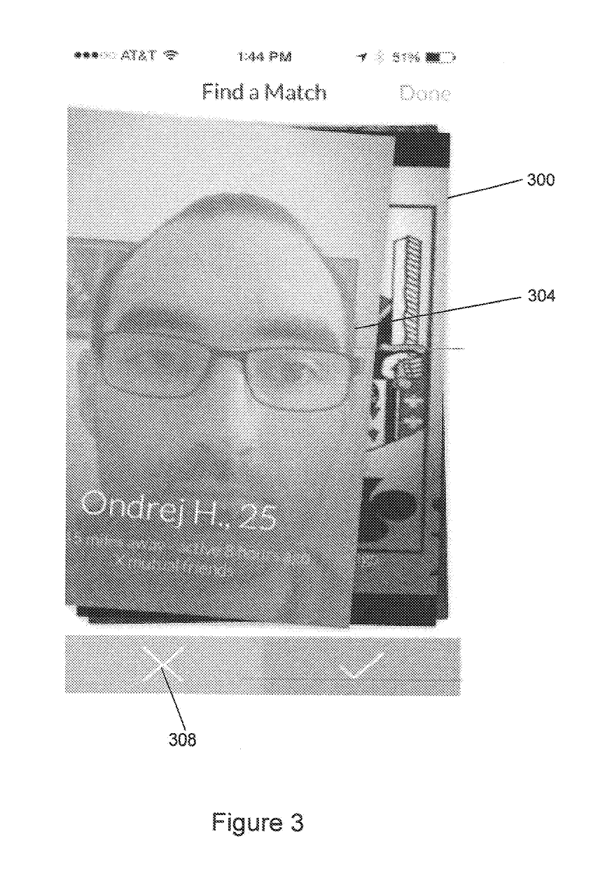

Turning now to FIG. 3, this figure presents a view of navigation when expressing no interest on the mobile social networking application consistent with certain embodiments of the present invention. In an exemplary embodiment, a first user may connect to the system and initiate a search. The search display 300 is presented to the first user with a view of an individual member of the social networking site who may be interested in connecting or matching with the first user. The system will present a graphical or icon representation for each individual connected to the site who is interested in pursuing a match. In a non-limiting example, the graphical or icon representation may be displayed as a photograph of the individual 304, however, other graphical or icon representations such as caricatures, icons, or any other digital representation may be accepted by the social networking site as a graphical or icon representation for each individual member.

In an embodiment, the first user views the photograph 304, or other member representation, and makes a decision as to whether to request a match. When searching, the first user may decide against requesting a match by swiping the photograph 304 in a particular direction to indicate that the first user is not interested in the social networking individual member represented by the photograph 304. In a non-limiting example, a swipe to the left may indicate a lack of interest such that the first user will not be requesting a match with that individual member at this time. When a swipe action is performed, the photograph 304 may acquire a red filter cover placed on the photograph 304 to indicate a “NO/NOT INTERESTED” status by the first user. In an alternative embodiment, the first user may instead select a button indicator 308 on the screen display. The button indicator 308 may be displayed as a red box containing a white “X”. Upon selection of this button indicator, the first user has indicated a “NO/NOT INTERESTED” status for the currently displayed individual member. As in the deselection using the swipe action, the photograph 304 may acquire a red, transparent filter cover to indicate the “NO/NOT INTERESTED” status. The red, transparent filter cover is stored as a status that remains with the photograph 304 such that if the photograph 304 is presented to the first user at a different time or in a different interaction with the social networking system, the first user may immediately determine that the first user had indicated a “NO/NOT INTERESTED” status during a previous interaction with the individual represented by the photograph 304.

The first user may continue to view newly presented graphical or icon representations, such as photographs, of additional individual members interested in forming matches on the social networking site. At each swipe or button selection action, the graphical or icon representation currently displayed may be replaced with a graphical or icon representation of a different individual member. In this manner, a first user may navigate through some portion, or all, of the individual members who have subscribed to the social networking site.

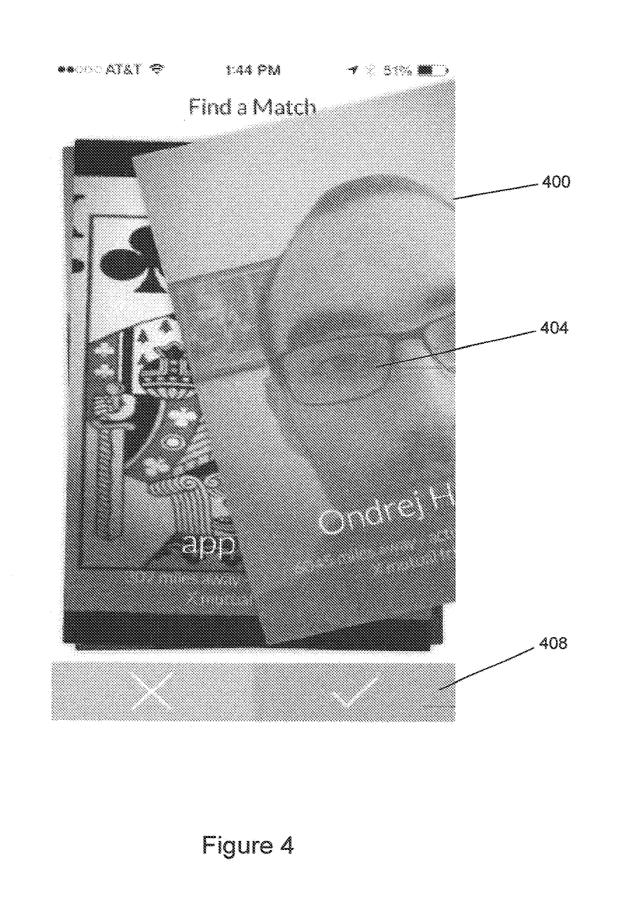

Turning now to FIG. 4, this figure presents a view of navigation when expressing interest on the mobile social networking application consistent with certain embodiments of the present invention. In an exemplary embodiment, a first user may connect to the system and initiate a search. The search display 400 is presented to the first user with a view of an individual member of the social networking site who may be interested in connecting or matching with the first user. The system will present a graphical or icon representation for each individual connected to the site who is interested in pursuing a match. In a non-limiting example, the graphical or icon representation may be displayed as a photograph of the individual 404, however, other graphical or icon representations such as caricatures, icons, or any other digital representation may be accepted by the social networking site as a graphical or icon representation for each individual member.

In an embodiment, the first user views the photograph 404, or other member representation, and makes a decision as to whether to request a match. When searching, the first user may decide to request a match by swiping the photograph 404 in a particular direction to indicate that the first user is not interested in the social networking individual member represented by the photograph 404. In a non-limiting example, a swipe to the right may indicate sufficient interest such that the first user will be requesting a match with that individual member at this time. When a swipe action is performed, the photograph 404 may acquire a green filter cover placed on the photograph 404 to indicate a “YES/INTERESTED” status by the first user. In an alternative embodiment, the first user may instead select a button indicator 408 on the screen display. The button indicator 308 may be displayed as a red box containing a white check mark. Upon selection of this button indicator, the first user has indicated a “YES/INTERESTED” status for the currently displayed individual member. As in the selection using the swipe action, the photograph 404 may acquire a green filter cover to indicate the “YES/INTERESTED” status.

When a first user indicates an interest in pursuing a match by swiping an individual member's photograph, or other graphical representation, to the right, the system activates a retrieval function. The retrieval function collects all of the selected individual member's submitted information and places this information into the database table or record maintained for one of the first user's open slots. The photograph, or other graphical representation, is placed in the portion of the display reserved for the slot with which the selected individual member's information is associated. In this manner, all of the slots permitted to the first user may be associated with detailed information about each individual member with whom the first user desires to be matched.

The first user may continue to view newly presented graphical or icon representations, such as photographs, of additional individual members interested in forming matches on the social networking site. At each swipe or button selection action, the graphical or icon representation currently displayed may be replaced with a graphical or icon representation of a different individual member. In this manner, a first user may navigate through some portion, or all, of the individual members who have subscribed to the social networking site creating matches until all of the slots associated with the first user are associated with the detailed information for matched individual members. When the first user has filled all of the slots allocated to the first member, the system may institute constraints on the actions of the user as previously described.

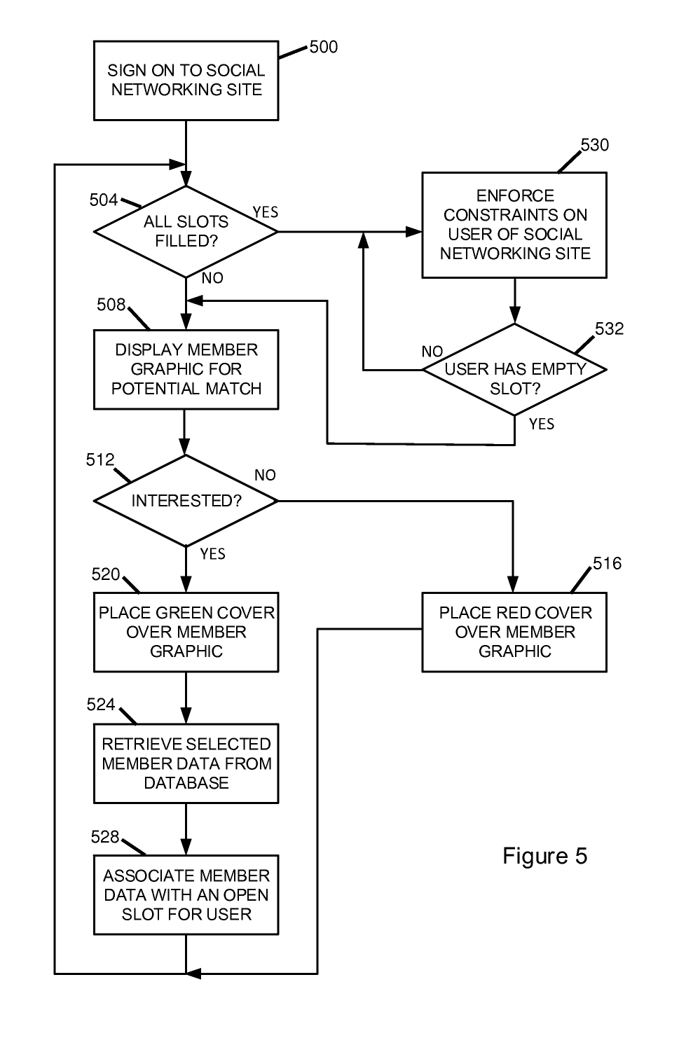

Turning now to FIG. 5, this figure presents an operational flow diagram for the social networking application consistent with certain embodiments of the present invention. In this embodiment, at step 500 a first user may activate interaction with the social networking site by signing on to the social networking site through a browser on a computer system, or through a dedicated application on a mobile device such as a smart phone, iPad, tablet, internet computer, or any other network capable device. In a non-limiting example, the social networking site may take the form of an application dedicated to matching individuals who are interested in pursuing social interaction in the form of sports group meetings, interest group meetups, dating, or any other social interaction in which selection of others having similar interests is important to a user of the system. In other non-limiting examples, the social networking site may take other forms of social matching interaction such as the selection of individuals in an entertainment casting activity, matching individuals in an employment selection activity, or any other matching action in which the first user is interested in selecting individuals from a group of members who have each subscribed to be included in the database maintained and managed by the social networking system.

Upon sign on, at step 504, the social networking system checks to determine whether the first user has the detailed information for individuals associated with all slots available to the first user. If the first user has one or more open slots, meaning that there are slots with no associated detailed information about another individual member registered with the social networking system, at step 508 the social networking system may present a first graphic representation of an individual member for the consideration as a potential match the first user may want to place in an empty slot. At step 512, the first user may make a choice regarding the presented individual member by swiping the graphic icon to the left to indicate no interest. If the first user indicates no interest, at step 516, the social networking system places a red, transparent overlay onto the graphic representation and replaces the graphic representation of the deselected individual member with a graphic representation of another individual member presented to the first user for matching consideration.

In the exemplary embodiment, if the first user is interested in the individual presented on the display at step 512, the first user may instead choose to swipe the graphic representation to the right to indicate interest in that individual member. At step 520, once the first user has indicated interest the social networking system places a green translucent overlay on the graphic representation of the individual member. At step 524, the social networking system retrieves all stored information about the selected individual member from the member database. At step 528, the retrieved member information is then replicated and placed into the slot database location for an open slot that is associated with the first user. The first user may continue to search the individual member database until all open slots contain information associated with selected individual members or until the first user ends the search activity.

In the exemplary embodiment, if all of the slots available to the first user contain information about selected individual members then the social networking system enables and enforces constraints on use of the social networking system at step 530. As previously indicated, constraints on interaction with the social networking site may take different forms based upon the configuration that the social networking site has determined to be the appropriate constraint. In a non-limiting example, a constraint may take the form of not permitting further searching action by the first user so long as all of their slots contain information from previously matched individuals. To remove the constraints on use of the social networking system and continue to interact with the system, the first user must make a match slot available. To do this, the first user must indicate to the social networking system that a slot is to be emptied of the information of an individual member current stored in the database maintaining and managing the slot information for users as previously described. Once the first user has directed the social networking system to empty the details of a previously selected individual member from a slot, the social networking system may check to determine if the first user has any empty slots at step 532. If the social networking system detects one or more empty slots, the constraints against use of the social networking system are removed with regard to the first user. The first user may then begin to search once again for individual members to add to any open slot, or perform any other action previously constrained by the social networking system when all slots are full.

If the first user has not successfully emptied a slot such that there are no open slots associated with the first user, the social networking system will continue to enforce the constraints on use of the system imposed when all slots associated with a first user are full.

While certain illustrative embodiments have been described, it is evident that many alternatives, modifications, permutations and variations will become apparent to those skilled in the art in light of the foregoing description.

What is claimed is:

1. A social networking system, comprising:
a display associated with a computer or mobile device;
a pre-configured number of match slots maintained by the social networking system and associated with a first user;
a search function operative to present a series of views of individual members of the social networking system to the first user;
a selection function operative to permit the first user to select a view of an individual member of the social networking system;
transferring detailed data associated with the selected individual member to a match slot associated with the first user;
the social networking system operative to constrain the first user from continued interaction with the social networking system when detailed information of selected individual members is associated with all of the pre-configured number of match slots associated with the first user.

2. The social networking system of claim 1, further comprising a database of individual member information that is searchable by the social networking system search function.

3. The social networking system of claim 1, where the display is optimized for a browser display.

4. The social networking system of claim 1, where the display is optimized for a mobile device display.

5. The social networking system of claim 1, where the selection function is operated by a first user through a swiping action by the first user, where the first user swipes a display to move a presented individual member display in either a first direction or a second direction opposite to the first direction and where the first direction indicates selection of that individual member.

6. The social networking system of claim 1, where constraining a first user comprises locking access to pre-configured social networking functions so as to remove those social networking functions from access by the first user.

7. The social networking system of claim 1, further comprising unlocking and restoring access to pre-configured social networking functions when any one of the match slots is accessible.

8. The social networking system of claim 7, where a match slot becomes accessible when the first user indicates to the social networking system that individual member information associated with any match slot should be disassociated from that match slot.

9. A social networking method, comprising:
displaying individual member information on a display associated with a computer or mobile device;
associating with a first user a pre-configured number of match slots maintained by a social networking system;
searching an individual member database to present a series of views of individual members of the social networking system to the first user;
the first user selecting a view of an individual member of the social networking system;
transferring detailed data associated with the selected individual member to a match slot associated with the first user;
the social networking system permitting or constraining the first user from continued interaction with the social networking system based upon at least one of the pre-configured number of match slots associated with the first user being available for association with selected individual member information.

10. The social networking method of claim 9, further comprising a database of individual member information that is searchable by a social networking system search function.

11. The social networking method of claim 9, where the display is optimized for a browser display.

12. The social networking method of claim 9, where the display is optimized for a mobile device display.

13. The social networking method of claim 9, where the selection function is operated by a first user through a swiping action by the first user, where the first user swipes a display to move a presented individual member display in either a first direction or a second direction opposite to the first direction, and where the first direction indicates selection of that individual member.

14. The social networking method of claim 9, where constraining a first user comprises locking access to pre-configured social networking functions so as to remove those social networking functions from access by the first user.

15. The social networking method of claim 9, where permitting access to a first user further comprises unlocking and restoring access to pre-configured social networking functions when any one of the match slots is accessible.

16. The social networking method of claim 15, where a match slot becomes accessible when the first user indicates to the social networking system that individual member information associated with any match slot should be disassociated from that match slot.
